(19) United States
(12) Patent Application Publication
(10) Pub. No.: US 2013/0221654 A1
(43) Pub. Date: Aug. 29, 2013

(54) LASER PRINTABLE MEDIA AND METHOD FOR USING SAME

(71) Applicants: Jonathan P. Kitchin, Leander, TX (US); Manisha Sarkar, Austin, TX (US)

(72) Inventors: Jonathan P. Kitchin, Leander, TX (US); Manisha Sarkar, Austin, TX (US)

(73) Assignee: 3M INNOVATIVE PROPERITES COMPANY, ST PAUL, MN (US)

(21) Appl. No.: 13/819,032

(22) PCT Filed: Aug. 26, 2011
(86) PCT No.: PCT/US11/49357

§ 371 Date: May 14, 2013

Related U.S. Application Data
(60) Provisional application No. 61/377,815, filed on Aug. 27, 2010.

(51) Int. Cl. B31D 1/02

(52) U.S. Cl. CPC B31D 1/021
USPC 283/81; 347/225

(57) ABSTRACT

A method for imaging laser printable media and media for use in such method.

### CROSS-REFERENCE TO RELATED APPLICATION

This application claims priority to U.S. Provisional Application No. 61/377,815, filed Aug. 27, 2010.

### FIELD

This invention relates to laser printable media, in particular to polyolefin-based laser printable media and methods of using same.

### BACKGROUND

Conformable film labels are preferred over paper labels for attachment to rough and curved surfaces as well as surfaces subject to dynamic flexing. Conformable films generally have low stiffness and are readily stretchable with a low level of elastic recovery. For instance, conformable film materials such as PVC have been used in applications where conformable performance is desired, e.g., name tabs to be worn on clothing and decorative “skins” for laptop computers and cell phones which have curved surfaces.

Because of concerns about potential environmental impact, alternatives to PVC are desired. Soft polyolefin films have been suggested as alternatives for PVC in many applications but due to the inferior temperature resistance of polyolefin films as compared to PVC, they have not been successfully used in applications where laser printing is used. For example, when exposed to the high temperature conditions of a color laser printer, typically on the order of about 150° C., such films commonly shrink, deform, melt, or stick to the imaging apparatus, yielding what is an aesthetically unacceptable product at best and being incapable of imaging at worst.

Several approaches to make polyolefin-based labels suitable for use in conjunction with laser printing have been suggested. For example, U.S. Pat. No. 5,543,191 (Dronzek, Jr. et al.) discloses sheets for printing with laser printers wherein the sheets are a multilayer film construction with balanced thermal expansion and contraction properties. U.S. Pat. No. 5,830,571 (Mann et al.) discloses constructions comprising heat resistant face stock, e.g., crosslinked polyolefin or nylon-6 outerlayer.

To date, however, none of these approaches has achieved desired performance. The need exists for cost effective conformable labels which can be imaged with laser printers to yield good quality, aesthetically appealing labels.

### SUMMARY

The present invention provides conformable media which can be imaged via laser printing to yield conformable, aesthetically pleasing image-bearing media. The present invention also provides a method for producing such image-bearing media.

In brief summary, a laser printable media of the invention comprises a polyolefin-based sheet having a first and a second major surface and a porous imaging layer on at least a portion of the first major surface. The media may optionally further comprise an adhesive layer on its second major surface and in some such embodiments still further optionally comprises a protective release liner covering the adhesive. Briefly summarizing, the method of the invention comprises providing such a laser media and passing it through a laser printer thereby printing an image on the imaging layer.

The invention is well suited for producing labels for use in demanding applications, e.g., name tags to be worn on clothing.

### BRIEF DESCRIPTION OF DRAWING

The invention is further explained with reference to the drawing wherein:

FIG. 1 is an idealized cross-sectional view of a portion of illustrative laser printable media of the invention;

These FIGURES are not to scale and are intended to be merely illustrative and not limiting.

### DETAILED DESCRIPTION OF ILLUSTRATIVE EMBODIMENTS

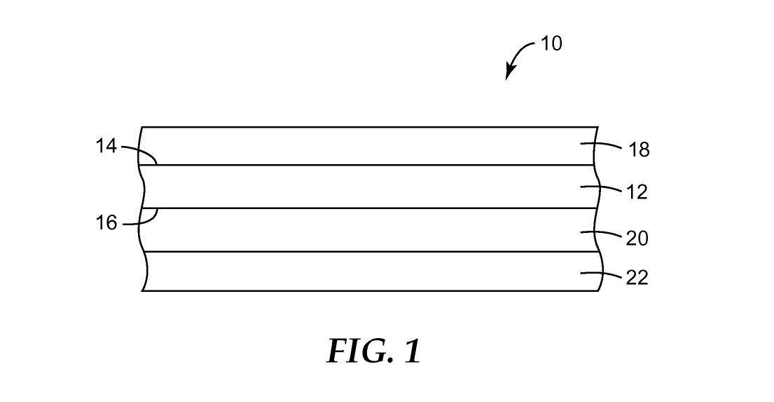

An illustrative embodiment of a laser printable media of the invention is shown in FIG. 1 wherein laser printable media 10 comprises sheet 12 having first or front major surface 14 and second or rear major surface 16. Media 10 further comprises imaging layer 18 on front major surface 14. In the embodiment shown, media 10 further comprises optional adhesive 20 on rear major surface 16 and optional adhesive 20 is covered by removable protective liner 22.

Sheet

The sheet comprises, and in some instances may consist essentially of, polyolefin. Typically the polyolefin is selected from the group consisting of polyethylene, polypropylene, and combinations thereof. A representative, but non-exclusive, list of polyolefins suitable for use as sheet includes polyethylene, polypropylene, polybutene (e.g., poly 1-butene), ethylene copolymers (such as linear low density polyethylene and other copolymers of ethylene and another monomer or monomers, e.g., hexene, butene, octene, etc.), propylene copolymers, butylene copolymers, and compatible blends thereof. Two polymeric materials are considered to be “compatible” if they are capable of existing in close and permanent physical association without exhibiting gross symptoms of polymer segregation. A polymer blend that is heterogenous on a macroscopic level is considered to be incompatible.

The sheet may further comprise copolymers to modify the properties of the resultant media as desired, e.g., higher carbon chain alkenes, to yield a softer, more conformable sheet.

An advantage of the present invention is that non-crosslinked polyolefin may be used, e.g., the polyolefin material in the sheet may be essentially free of any crosslinking Because of the relative stiffening effect of crosslinking, in such embodiments of the invention can be used to attain highly conformable imaged media.

The sheet is typically preferably between about 30 and about 100 microns in thickness, though sheets with other thicknesses may be used if desired.

Typically it is preferred that the sheet have a tensile elongation at break (ASTM D638) of greater than about 100%, and more preferably greater than about 300%.

As will be understood, the sheet may further contain plasticizers, antioxidants, stabilizers, UV stabilizers, and other additives.

In some instances, the sheet may be processed in such a way as to induce vesicles or voids which make it white.

In some embodiments, suitable sheets films comprising polyolefin film may be manufactured in multilayer form, e.g., as a coextruded multi-layer film, such that the composition of the outer layer, or layers, is different from that of the inner layer, or layers. The outer layers of a multi-layer film may be modified to optimize surface properties such as gloss, smoothness, electrical resistivity, adhesion to subsequent coatings, etc. whereas the bulk properties of the sheet are defined in large part by the properties of the polyolefin. Such multilayer materials are sometimes referred to herein as polyolefin sheets.

The surface of the sheet may be exposed to a corona discharge or otherwise modified to improve adhesion of subsequent coatings.

The polyolefin sheet may be substantially transparent, translucent, white, or other color as desired. As will be understood by those skilled in the art, desired color, opacity, etc. may be attained by incorporation of coloring agents, e.g., dye(s) and/or pigment(s).

Typically, the sheet will be substantially free of PVC, i.e., it will not contain any PVC.

Imaging Layer

The imaging layer is a porous layer comprising a binder and amorphous precipitated silica. In some preferred embodiments it will further comprise fumed silicas. The binder is preferably a water-based ethylene-acrylic acid copolymer dispersion or an ethylene-vinyl acetate copolymer dispersion. However, any polymeric binder may be used which can provide a flexible and durable film that does not flake or crack when the resultant media sheet is flexed or stretched.

The porosity of the imaging layer may be characterized by the void volume which is defined in ASTM D792 as the density of the bulk coating divided by the averaged density of the solid components expressed as a percentage. The void volume may be calculated from the known solid densities of the components of the coating and measurement of the bulk density of the coating. Alternatively the void volume may be measured by weighing the coating then saturating the coating with liquid of a known density and reweighing as described in ASTM D792. Void volume in the range of from about 20% to about 90% is typically preferred.

The weight percent ratio of silica to binder can range from about 3.5:1 to about 0.5:1 and preferably from about 2:1 to about 1:1.

The thickness of the imaging layer is typically from about 10 to about 60 microns, preferably from about 20 to about 40 microns

The binder can be any polymer from water-based or organic solvent-based systems that can be coated onto the polyolefin sheet and can adhere to the material with the silica particles contained therein. Preferably, the binder is water-resistant, yet can be coated from a water-based dispersion. Nonlimiting examples of suitable binders include ethylene-acrylic acid copolymers and their salts, styrene-acrylic acid copolymers and their salts, ethylene vinyl acetate copolymers, poly vinyl alcohol, and other (meth)acrylic moiety containing polymers.

The binder retains silicas in the imaging layer. Silicas useful in the invention include amorphous precipitated silicas alone or in mixture with fumed silicas.

Such silicas have typical primary particle sizes ranging from about 15 nm to about 6 μm. These particle sizes have great range, because two different types of silicas are useful in the present invention. The optional fumed silicas have a much smaller particle size than the amorphous precipitated silicas and typically constitute the lesser proportion of the mixture of silicas when both are present. Generally when both are present in the mixture, the weight ratio of silicas (amorphous:fumed) ranges greater than about 1:1 and preferably greater than about 3:1.

Suitable amorphous precipitated silicas are commercially available such as FK-3 silicas from Degussa Corporation and similar materials from such sources as Evonik Corporation and W.R. Grace Corporation.

Suitable fumed silicas are commercially available as CAB-O-SIL® Silicas from Cabot Corp. of Tuscola, Ill., U.S.A. and AEROSIL® MOX 170 silicas from Evonik Corporation.

The imaging layer is constructed applying a range of weight ratio of silica to binder and applied in a range of coating weights such that the dried layer acts as a thermally insulating layer to shield the underlying polyolefin sheet of the media from the heat of the fuser roll of a laser printer or copier. The thermally insulating effect of the coating minimizes the thermal sink effect of the underlying polyolefin film which can lead to poor toner fusing. The weight ratio of silica to binder must also be balanced to provide an adequately flexible, durable and non-brittle coating. Suitable weight ratio for specific embodiments can be readily selected by those skilled in the art.

The silica to binder ratio and the chemical nature of the binder are further selected such that the coating does not become significantly tacky or sticky when passed through the hot fuser roll section of a laser printer of copier is capable.

The imaging layers disclosed in U.S. Pat. No. 6,114,022 (Warner et al.) can be used on media of the present invention. While that reference teaches their utility in inkjet media, it is only now that their utility in laser printing media and the surprising results attained therein have been appreciated.

Method of Making the Imaging Layer

Coating can be carried out using dispersions of between approximately 5% and 40% solids onto the polyolefin sheet by any of a variety of well-known coating methods including, e.g., knife coating, Mayer rod coating, gravure coating, and slot die coating.

In one embodiment, one can construct the laser printable medium by coating adhesive on a release liner, laminating the polyolefin sheet to the adhesive, and then applying the imaging layer to the exposed surface of the polyolefin film

In another embodiment, one can laminate the polyolefin film to an adhesive on a transfer liner and then transfer to the final release liner either before or after coating the imaging layer.

Optional Adhesive Layer and Optional Release Liner

The laser printable sheet optionally but preferably has an adhesive layer on the opposite major surface of the polyolefin sheet that is also optionally but preferably protected by a release liner. After imaging, the sheet can be adhered to a horizontal or vertical, interior or exterior surface including garments, laptop computers, cell phones to warn, identify, decorate, educate, entertain, advertise, etc.

The choice of adhesive and release liner depends on usage desired for the image graphic.

Pressure sensitive adhesives can be any conventional pressure sensitive adhesive that adheres to both membrane and to the surface of the item upon which the inkjet receptor medium having the permanent, precise image is destined to be placed. Pressure sensitive adhesives are generally described in Satas, Ed., Handbook of Pressure Sensitive Adhesives 2nd Ed. (Von Nostrand Reinhold 1989), which is incorporated herein by reference in its entirety. Pressure sensitive adhesives are commercially available from a number of sources. Particularly preferred are acrylate pressure sensitive adhesives commercially available from 3M Company and generally described in U.S. Pat. Nos. 4,605,592 (Paquette et al.); 5,045,386 (Stan et al.); 5,141,797 (Wheeler); and 5,229,207 (Paquette et al.); and European Patent Publication EP 0 570 515 B1 (Steelman et al.).

Release liners are also well known and commercially available from a number of sources. Nonlimiting examples of release liners include silicone coated kraft paper, silicone coated polyethylene coated paper, silicone coated or non-coated polymeric materials such as polyethylene or polypropylene, as well as the aforementioned base materials coated with polymeric release agents such as silicone urea, urethanes, and long chain alkyl acrylates, such as defined in U.S. Pat. Nos. 3,957,724 (Schurb et al.); 3,997,702 (Schurb et al.); 4,313,988 (Koshar et al.); 4,567,073 (Larson et al.); 4,614,667 (Larson et al.); 5,202,190 (Kantner et al.); and 5,290,615 (Tushaus et al.); the disclosures of which are incorporated by reference herein and those liners commercially available as POLY SLIK® release liners from Loparex LLC.(formerly Rexam Release) and EXHERE® release liners from P. H. Glatfelter Company.

Applications

The laser printable media of the invention may be imaged or printed on using commercially available laser printers and copiers, for example printers manufactured by Hewlett Packard, Xerox, Lexmark, Brother, Canon, and Samsung. Both color and monochrome laser printers may be used.

Typically, printing with a laser printer or laser copier comprises 1) forming a latent image on a photoreceptive imaging drum, 2) applying toner to the latent image in an imagewise fashion, 3) transferring toner from the imaging drum to the front face of the media, sometimes by direct contact, sometimes via a transfer belt, and 4) fixing the image on the media by application of pressure and heat such as with a fuser roll, e.g., typically at temperatures of at least about 150° C., in some embodiments at temperatures of at least about 200° C.

Media of the invention may be used in any of a variety of well know configurations including rolls and sheets (e.g., standard letter size, A4, or others). As will be understood, media of the invention can be made in label form in desired dimension and shape, for instance, the polyolefin sheet may comprise one or more weakened or complete lines of separation, e.g., perforations, partial or complete slits, etc., that on a single liner.

### EXAMPLE

The invention is further explained in the following illustrative example.

White, 80 micron thick polypropylene film available from Rocheux International was laminated with a permanent acrylic adhesive available from Cytec Corp. to 78 lb (35 kg) clay coated kraft paper/silcone release liner.

This label stock was top coated as follows on a laboratory scale to prepare media of the invention. A coating composition for forming an imaging layer of the invention was prepared as follows: 4.0 g of deionized water was mixed with 40.5 g of precipitated amorphous silica (Evonik SIPERNAT® 310 Silica—15% pre-mix in water) and 16.9 g of a second grade of amorphous precipitated silica (Evonik SIPERNAT® 500 LS (12.5% pre-mix in water). To this mixture were added: 3.3 g of 25% polyvinyl alcohol in water (CELVOL® 24203), 3.1 g of 35% polyvinyl pyrrolidinone in water (LUVITEC® K-60), 0.7 g of 20% polydiallyldimethylammonium chloride in water (FLOQUAT® 4440) and 6.1 g of 55% ethylene vinyl acetate latex in water (VINNAPAS® 920). After mixing thoroughly, the resultant coating composition was applied to the polyolefin label stock using a knife coater at a thickness calculated to give a dry coat weight of 1.2 g/ft² (13 g/m²). The coating was dried in an oven at 150° F. (66° C.) for 2 minutes.

Coated sheets of the label stock were imaged in a HP CP1215 laser printer at the default plain paper setting with excellent image quality. Uncoated sheets of the same label stock exhibited extremely poor (mottled and blotchy) images.

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom. The complete disclosure of all patents, patent documents, and publications cited herein are incorporated be reference.

1. A method for imaging comprising: (a) providing a laser printable media comprising a polyolefin sheet having a first and a second major surface and a porous imaging layer comprising a binder and amorphous precipitated silica on at least a portion of the first major surface; (b) passing said media through a laser printer and printing on said imaging layer.

2. The method of claim 1 wherein said polyolefin sheet comprises a polyolefin selected from the group consisting of polyethylene, polypropylene, polybutylene, ethylene copolymers, propylene copolymers, butylene copolymers, and blends thereof.

3. The method of claim 1 wherein said polyolefin sheet consists essentially of polyethylene, polypropylene, polybutylene, ethylene copolymers, propylene copolymers, butylene copolymers, and blends thereof.

4. The method of claim 1 wherein the polyolefin content of said polyolefin sheet is substantially non-crosslinked.

5. The method of claim 1 wherein said polyolefin sheet is from about 30 to about 100 microns thick.

6. The method of claim 1 wherein said polyolefin sheet has a tensile elongation at break of greater than about 100% as measured by ASTM D638.

7. The method of claim 1 wherein said polyolefin sheet has a tensile elongation at break of greater than about 300% as measured by ASTM D638.

8. The method of claim 1 wherein said polyolefin sheet is multilayer.

9. (canceled)

10. The method of claim 1 wherein said binder is water-based ethylene-acrylic acid copolymer or an ethylene vinyl acetate copolymer dispersion.

11. The method of claim 1 further comprising fumed silica.

12. The method of claim 11 wherein the weight ratio of said amorphous silica to said fumed silica is greater than about 1:1.

13. The method of claim 11 wherein the weight ratio of said amorphous silica to said fumed silica is greater than about 3:1.

14. The method of claim 1 wherein the weight percent ratio of silica to binder is from about 3.5:1 to about 0.5:1.

15. The method of claim 1 wherein the weight percent ratio of silica to binder is from about 2:1 to about 1:1.

16. The method of claim 1 wherein said silica have-has a primary particle size of from about 15 nm to about 60 um.

17. The method of claim 1 wherein said imaging layer has a thickness from about 10 to about 60 microns.

18. The method of claim 1 wherein said imaging layer has a thickness from about 20 to about 40 microns.

19. The method of claim 1 wherein said imaging layer has a void volume of from about 20 to about 90% as measured by ASTM D792.

20. The method of claim 1 wherein said media further comprises adhesive on at least a portion of said second major surface.

21. The method of claim 20 wherein said media further comprises a release liner covering said adhesive.

22. The method of claim 21 further comprising separating said release liner from said media and adhering said media to a substrate with said adhesive.

23. The method of claim 1 wherein said media is configured in roll form.

24. The method of claim 1 wherein said media is configured in sheet form.

25. A printed label, sticker or decal formed by the method of claim 1.
